(19) United States
(12) Patent Application Publication
(10) Pub. No.: US 2006/0242760 A1
(43) Pub. Date: Nov. 2, 2006

(54) Spa tub apparatus

(76) Inventor: Tai Pao Chao, Lilburn, GA (US)

Correspondence Address: LAW OFFICES OF CLEMENT CHENG, 17220 NEWHOPE STREET #127, FOUNTAIN VALLEY, CA, 92708, US

(21) Appl. No.: 11/118,595

(22) Filed: Apr. 28, 2005

(51) Int. Cl. A47K 3/022; A61H 35/00; E03C 1/00

(52) U.S. Cl. 4/622

(57) ABSTRACT

A spa tub apparatus comprising a spa tub, a liner fitting within the spa tub for holding water in motion, and a jet unit having a housing attached to an inside surface of the liner. The liner is waterproof and conforms to the shape of the spa tub. The housing optionally forms a hook on the jet unit housing that is adapted to attach the jet unit to the inside surface of the liner when the jet unit is hooked onto the liner.

### DISCUSSION OF RELATED ART

A wide variety of spa jets have been used in foot spas. Traditionally, a spa tub had a number of outlets and inlets. Water was taken from the drain in the bottom of the tub, pumped through conduits and then recirculated through jets to be directed at the users body. Unfortunately, a busy salon shop would have less time to clean the system. Pedicure foot spa tubs numbering more than 70,000 medium to large size stores around the nation provide foot spa treatments. Because of the large number of foot spa customers that pass through a salon each day, there is a risk and potential for epidemic outbreaks of bacteria or fungus.

The dirty water from the previous client remains in the pipe system even if the tub is thoroughly cleaned. The residual water is pumped out and mixed with new clean water that can spread infection to the next client. A recent advancement as seen in U.S. Pat. No. 6,836,908 and U.S. Pat. No. 5,414,878 uses pipeless jets eliminating dirty water retained in conduits, but is difficult to disassemble and clean in between customers. This may lead to lack of any kind of cleaning of the jet heads allowing bacteria and fungus to grow in the jet head.

### BRIEF DESCRIPTION OF THE DRAWINGS

FIG. 1 is a foot spa of the prior art.

FIG. 2 is an exploded view of the present invention showing the chair, the liner, and the recirculating pumps.

FIG. 3 is an exploded view of the liner fitting with the recirculating pumps.

FIG. 4 is an exploded view of the recirculating pump.

### DETAILED DESCRIPTION OF THE PREFERRED EMBODIMENT

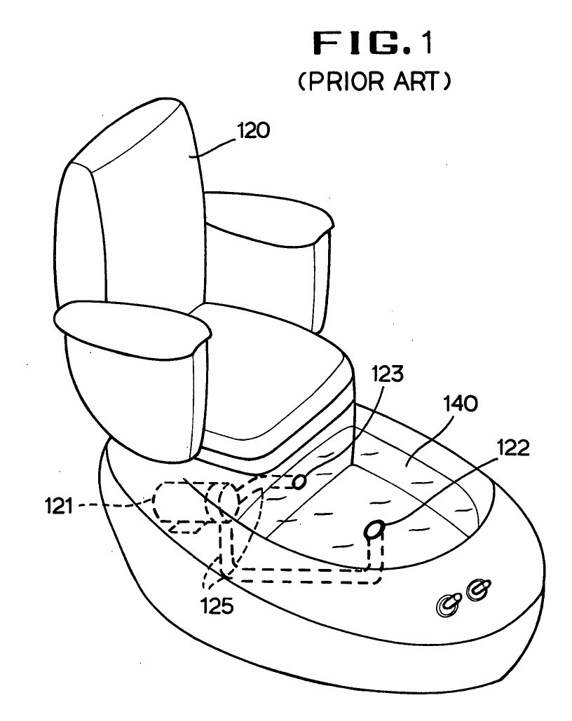

According to the prior art FIG. 1, the patron is seated on the spa chair 120. Water fills the spa chair tub 140 and a motor 121 powers a pump that is mounted under the chair. The pump sends massaging jets of water directed to the customer's feet. The water is circulated from the drain 122 to the jet 123 through a network of conduits 125.

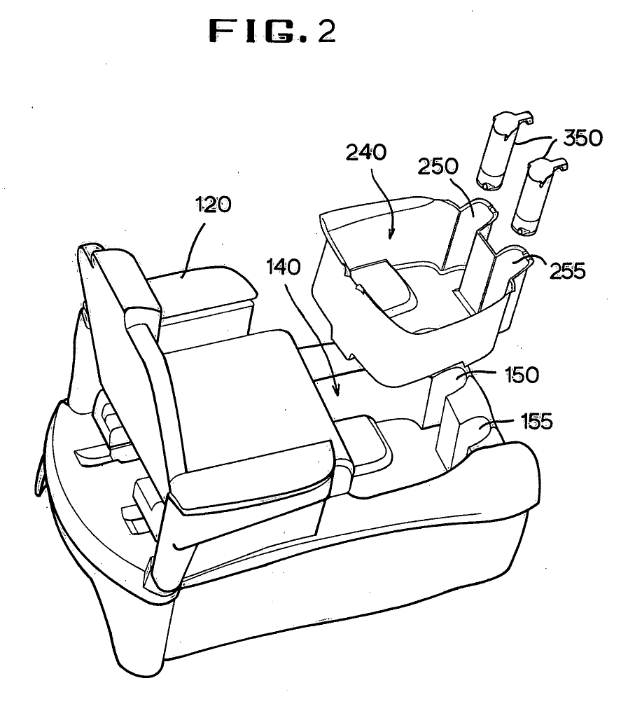

The present embodiment FIG. 2 has a liner 240 adapting to the tub 140. The liner 240 is changed for each customer keeping the tub 140 dry. Preferably, the liners 240 nest so that they can be stacked for storage, disposal or shipping. To avoid contamination, the liner 240 can be disposable and discarded after single use. The spa tub walls 140 need not contact water, and serve as a frame for supporting the water filled liner 240.

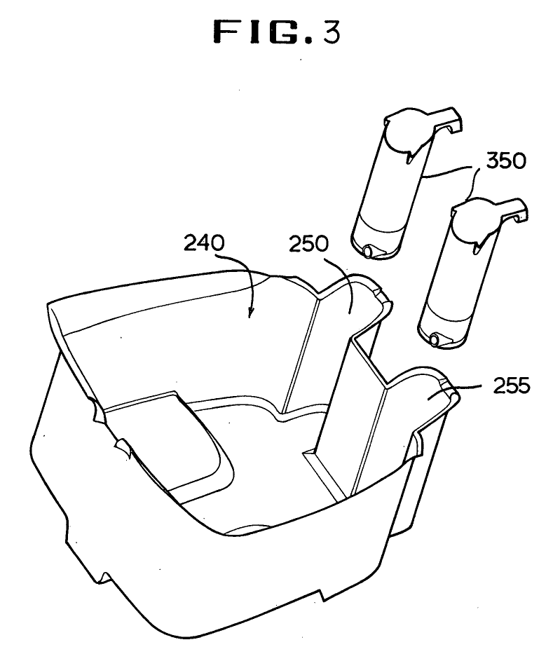

The liner 240 is preferably a plastic rigid shell for holding water. The liner can be adapted with a valve or hole to affix to the drain. Therefore, the water can flow from the bottom of the liner down the drain of the chair spa tub. A watertight seal is affixed between the liner drain and the tub drain. Optionally, the liner can be formed without a drain hole so that it would be emptied manually FIG. 2. In both cases, the liner adapts to a snug fit to the tub. The liner 240, FIG. 3 additionally has at least one retainer 250 and possible a second retainer 255 preferably formed as cylindrical slots 250, 255 for modularly receiving one or a plurality of cylindrical hang on jet units 350. The jet units can be submersible if made watertight. The hang on jet units 350 power a jet of water directed toward a user's feet.

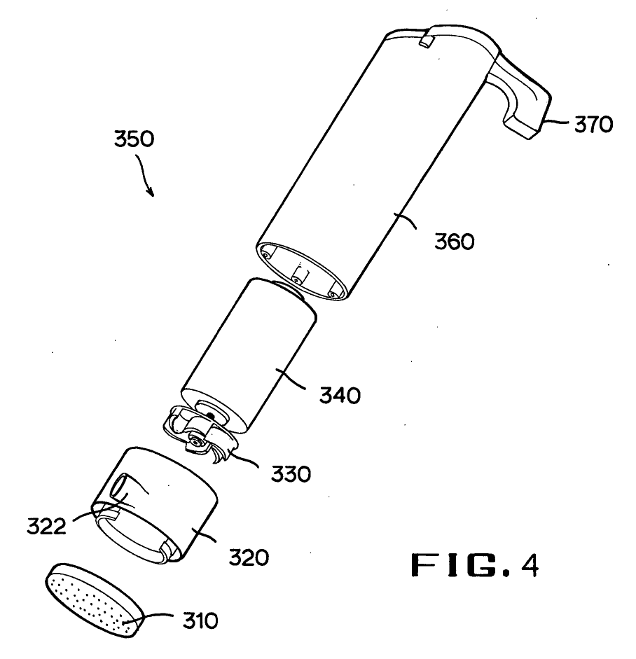

The hang on jet unit 350, FIG. 4 is comprised of a housing 360, a pump motor 340, an impeller 330, a jet outlet 322 and a water intake port 310. At the top of the housing 370, the motor 340 is electrically connected to an electrical connector or alternatively the motor power cord extends from the top of the housing. The pump uses preferably cylindrical having and electrical connection at the top end. The electrical connection can be built as contacts into the spa chair, or optionally electrical cord can power the pump.

In addition to attaching the pump by a hang on system that fits in a slot 250, a submersible pump can also attach in any wide variety of ways to the wall of the liner. The jet unit 350 can be hung on to the liner via a variety of means. For example, suction cups can attach the jet unit 350 to the liner. The liner can be adapted with slots or protrusions that engage and retain the jet unit 350. The jet unit 350 can also be placed on the inside surface floor of the liner. In any case, the jet unit 350 is attached to the inside wall of the liner so that when the jets are activated, the jet unit 350 does not float away.

The best mode currently known for attaching the jet unit 350 to the liner 240 is by forming a hook at the top end 370 of the jet unit 350 that allows the jet unit to hang over the edge of the tub and the liner. For an electrical cylindrical shape pump, the liner can also appropriately have a cylindrical depression forming a receptacle retaining the pump. The foot spa chair would also have the same depressions conforming to the liner.

The modular nature of the spa tub 140, liner 240, and jet unit 350 is to allow easier use, storage and cleaning. A worker can set up the spa chair 120 by obtaining a clean liner 240 and clean set of jet units 350. The worker puts the liner 240 into the spa chair tub 140 and jet units 350 into the pump holders 250, 255 formed in the liner. The user then activates the electrical connection.

The present embodiment can be adapted for use in a variety of different shaped bathtubs or spa chair tubs. The jet unit pumps can be cleaned by hanging, attaching or submerging them on a liner filled with cleaning solution and activating the pump to circulate cleaning solution through the jet unit 350.

As an alternate embodiment, the liner can be removed before use allowing the cylindrical jet pumps to hang inside the cylindrical recesses allowing the tub to be used to hold water. This method is not preferred due to the lack of sanitation because dirty water can potentially contaminate the tub.

1. A spa tub apparatus comprising: a spa tub for holding water in motion, a jet unit having a housing attached to an inside surface of the spa tub, wherein the spa tub is waterproof.

2. The spa tub apparatus of claim 1, further comprising a hook formed on the jet unit housing, the hook adapted to attach the jet unit to the inside surface of the spa tub when the jet unit is hooked onto the spa tub.

3. The spa tub apparatus of claim 1, wherein the tub has no drain hole.

4. The spa tub apparatus of claim 1, wherein the spa has a tub drain hole.

5. The spa tub apparatus of claim 1, wherein the jet unit comprises a housing, a motor, an impeller, a jet outlet and a jet inlet.

6. A spa tub apparatus comprising: a spa tub, a liner fitting within the spa tub for holding water in motion, wherein the liner is waterproof and forms a jet unit holder, a jet unit having a housing that attaches and detaches to the jet unit holder.

7. The spa tub apparatus of claim 6, wherein the jet unit holder is a cylindrical slot holding a cylindrical jet unit.

8. The spa tub apparatus of claim 6, further comprising a hook formed on the jet unit adapted to hang the jet unit to the liner.

9. The spa tub apparatus of claim 6, further comprising a hook formed on the jet unit housing, the hook adapted to attach the jet unit to the inside surface of the liner when the jet unit is hooked onto the liner.

10. The spa tub apparatus of claim 6, wherein the liner has no drain hole.

11. The spa tub apparatus of claim 6, wherein the liner has a liner drain hole fitting atop a spa tub drain hole.

12. A spa tub apparatus comprising: a spa tub, a liner fitting within the spa tub for holding water in motion, wherein the liner is waterproof and forms a jet unit holder, a jet unit having a housing that attaches and detaches to the jet unit holder, wherein the jet unit comprises a housing, a motor, an impeller, a jet outlet and a jet inlet, wherein the jet unit holder is a cylindrical slot holding a cylindrical jet unit.

13. The spa tub apparatus of claim 12, further comprising a hook formed on the jet unit housing, the hook adapted to attach the jet unit to the inside surface of the liner when the jet unit is hooked onto the liner.

14. The spa tub apparatus of claim 12, wherein the liner has no drain hole.
